(19) United States
(12) Patent Application Publication
(10) Pub. No.: US 2025/0364858 A1
(43) Pub. Date: Nov. 27, 2025

(54) AN ELECTRIC MACHINE AND METHOD OF USE

(71) Applicant: Petroliam Nasional Berhad (PETRONAS), Kuala Lumpur (MY)

(72) Inventors: Muhammad Fadhli MUHAMMAD, Kuala Lumpur (MY); Asmadi MANSOR, Kuala Lumpur (MY); Firmansyah -, Kuala Lumpur (MY); Safwan Hanis Bin MOHD MURAD, Kuala Lumpur (MY)

(73) Assignee: Petroliam Nasional Berhad (PETRONAS), Kuala Lumpur (MY)

(21) Appl. No.: 18/867,511

(22) PCT Filed: May 13, 2023
(86) PCT No.: PCT/MY2023/050035

§ 371 Date: Nov. 20, 2024

(30) Foreign Application Priority Data
May 20, 2022 (MY) PI2022002628

(51) Int. Cl. H02K 3/02; H02K 3/24; H02K 5/20; H02K 7/18; H02K 9/193

(52) U.S. Cl. CPC H02K 3/02; H02K 3/24; H02K 5/20; H02K 7/1823; H02K 9/193

(57) ABSTRACT

An electric generator, comprising: a housing; an inlet for receiving gas into said housing; a rotor operatively rotatable through contact with said fluid; said rotor having at least one magnetic element attached to its inside; a stator winding assembly having a coreless stator winding arranged to interact with said magnetic element; wherein said stator winding assembly having a dismantlable casing arranged to seal the coreless stator winding from said gas inflow.

### FIELD OF THE INVENTION

The invention relates to electric machines, either in the form of a generator or a motor. In particular, the invention relates to non-combustion electric machines.

### BACKGROUND

There is a need to develop power devices for remote locations, for instance, offshore platforms and rural drilling rigs. There is future opportunity to use the potential energy from natural gas steams at such sites. To this end, non-combustion electric generators have been developed. Such systems have several shortcomings. For instance, energy conversion to operate the rotor is traditionally inefficient. Further, stator windings using prior art principles are inappropriate for such applications. Conventional stator winding assemblies are typically made up from thin insulated wires wound around laminated cores to make up the required number of coil loops. They further include electrical phase leads and sensors leads such as resistance temperature detector (RTD) leads positioned or soldered at the intended location on the stator. The assembly is encapsulated into mould pack to form its final shape through curing of epoxy resin.

The manufacturing for such stator windings assemblies is laborious. At each stage of the process, everything has to be done correctly with little room for error. Further, after casting, it is irreversible and difficult to repair. The moulded housing also has to be porosity free as it needs to handle heat and pressure build up during operation, which makes the manufacturing more critical and difficult.

Under pressure operation, the encapsulation may have cracks. Also, the joint faces between the lamination stack and the exit points of the electrical phase leads and sensor leads connected with electrical glands may offer potential ingress of fluid, such as gas, into the stator windings assembly causing short circuit.

Further, the stator winding assemblies may suffer high temperature under long-time continuous operation due to encapsulation, resulting in increase of resistance of the coil windings. Thus, the working efficiency of the stator winding assemblies may be undermined. Overheating may further reduce the stability and durability of the stator winding assemblies.

### SUMMARY OF THE INVENTION

In a first aspect, the invention provides an electric generator, comprising: a housing; an inlet for receiving gas into said housing; a rotor operatively rotatable through contact with said fluid; said rotor having at least one magnetic element attached to its inside; a stator winding assembly having a coreless stator winding arranged to interact with said magnetic element; wherein said stator winding assembly having a dismantlable casing arranged to seal the coreless stator winding from said gas inflow.

In a second aspect, the invention provides a rotor having curved blades in contact with an incoming gas to receive the energy imparted by the gas and drive the rotor. In this case, the energy conversion is more efficient as compared to a frictional transfer based on a continuous impingement surface of a rotor in a prior art device.

In a third aspect, the invention provides a dismantlable casing of a stator winding assembly which is formed by a machined outer housing and a machined hub detachably mounted onto the outer housing. Compared to the conventional encapsulation molding used in prior arts, the manufacturing turnaround is faster and cheaper with additional flexibility for revision of the design of the machined outer housing and hub. In alternative embodiments, the outer housing and/or hub may be manufactured using different techniques, including injection moulding and additive manufacturing processes, including 3D printing.

Further, the coil windings can be easily taken out of the casing by detaching the outer housing and the hub. This is advantageous over an encapsulation molding, which requires destructive effort for dismantling. Thus, it is rather convenient to carry out inspection for the winding conditions and maintenance for the stator winding assembly. Also, it may accelerate troubleshooting activity if required.

In a fourth aspect, the invention provides a cooling system comprising a transformer oil supplied into the stator winding assembly to cool down the coil windings; an oil tank containing the transformer oil: the transformer oil may circulate in between the stator winding assembly and oil tank: a submersible miniature pump for consistent supply of the transformer oil into the stator winding assembly; and a cooling fin with inverted finned structure arranged to recirculate the outflow gas into the tank to cool down the transformer oil through heat transfer. This cooling system protects the stator winding assembly from suffering high temperature under long-term continuous operation and ensures a consistent working efficiency of the stator winding assembly. Further, the cooling system improves the stability and durability of the stator winding assembly, as compared to a stator winding assembly without cooling system in a prior art.

In a fifth aspect, the invention provides hermetic electric connectors at exit ports of electrical leads to avert leakage under pressure operation, which may occur when electrical gland connections are used for the electrical leads.

### BRIEF DESCRIPTION OF DRAWINGS

It will be convenient to further describe the present invention with respect to the accompanying drawings that illustrate possible arrangements of the invention. Other arrangements of the invention are possible and consequently, the particularity of the accompanying drawings is not to be understood as superseding the generality of the preceding description of the invention.

FIGS. 1A and 1B are perspective views of an electric generator according to one embodiment of the invention;

FIGS. 2A and 2B are various views of an electric generator according to one embodiment of the invention;

FIG. 3 is a cut-away perspective view of an electric generator according to one embodiment of the invention;

FIGS. 4A and 4B are perspective views of a stator winding assembly according to one embodiment of the invention;

FIG. 5 is a sectional view of a stator winding assembly according to one embodiment of the invention:

FIG. 6 is an exploded view of a stator winding assembly according to one embodiment of the invention:

FIGS. 7A to 7D are various views of a cooling assembly according to one embodiment of the present invention

### DETAILED DESCRIPTION

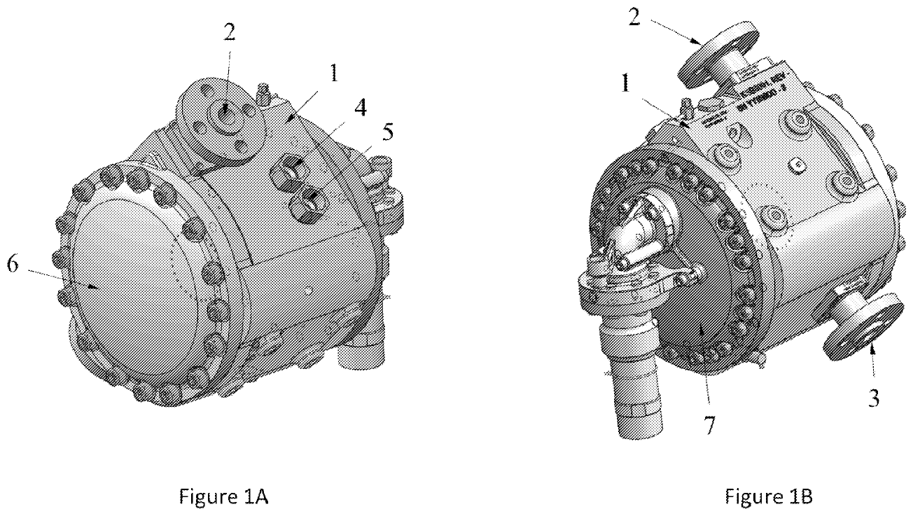

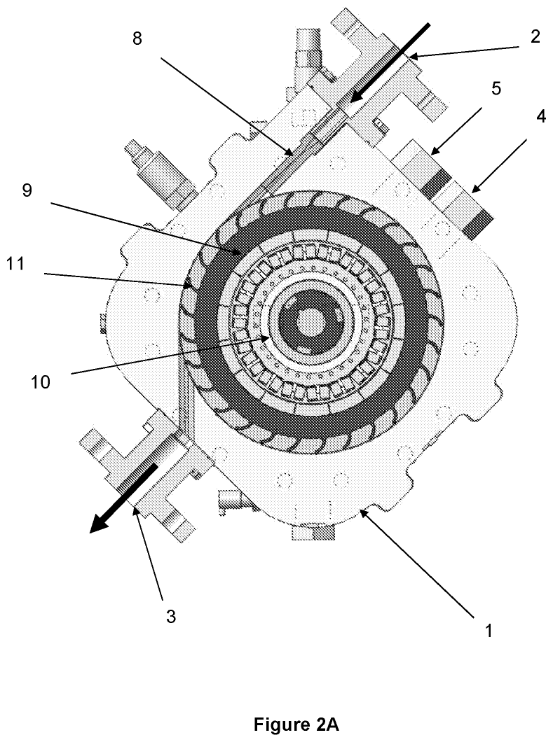

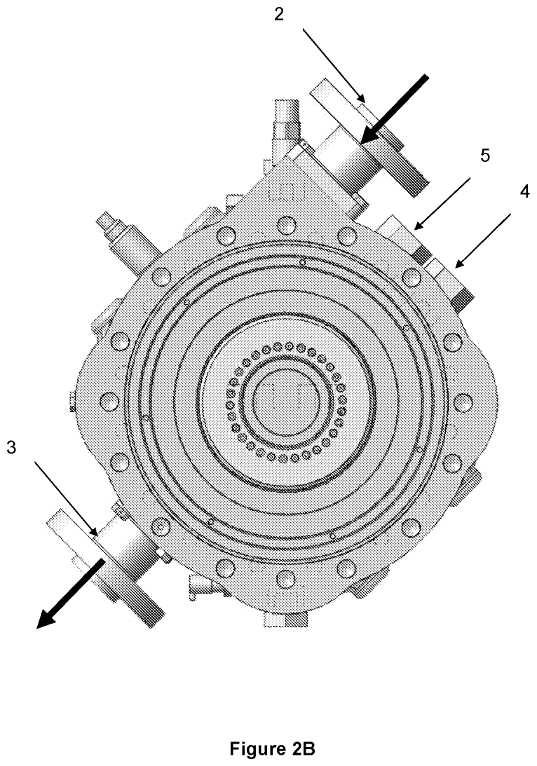

FIGS. 1A, 1B, 2A, 2B and 3 show an exemplary embodiment of an electric machine, in this case a generator, having a housing 1. The housing 1 has a front cover 6 and a rear cover 7. In one embodiment, the covers may withstand pressure up to 100 bar. The housing further includes a gas inlet 2 for receiving high-pressure inflow fluid, such as gas, into the housing. The high-pressure inflow gas will first pass through a converging-diverging nozzle 8 to achieve desired speed and impinge onto the inside surface of curved blades 11 of a rotor 9. Thus, the rotor 9 may be driven by the high-pressure gas and rotates accordingly. The curved blades are to receive the energy imparted by the gas, resulting in a more efficient energy conversion as compared to a frictional transfer based on a continuous impingement surface of a rotor in a prior art device. There is at least one magnet element attached to the inside of the rotor 9, which rotates together with the rotor 9 and creates a changing magnetic field. This changing magnetic field may interact with a stator winding assembly 10 and generate electrical power. The stator winding assembly 10 may be hermetically sealed from the gas inflow within a casing 12. The casing 12 may be dismantlable and allow the inner parts of the stator winding assembly 10 to be taken out for inspection and maintenance. The casing 12 may be bolted, screw-fitted, snap-fitted and any other assembling means suitable for gas sealing and dismantling. Thereafter, the outflow gas will exit from the housing through outlet 3, at a much lower energy gradient to the inflow gas.

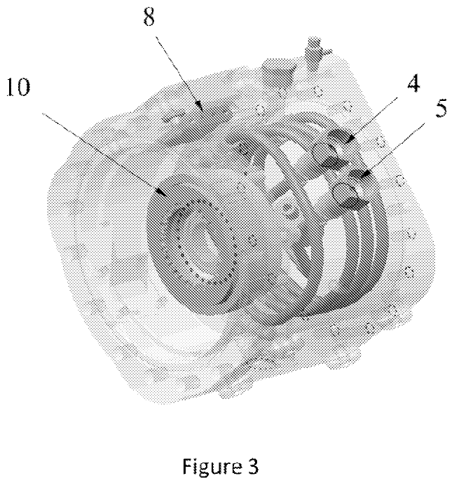

The housing further includes a cooling system having a fluid inlet 4 to receive an insulating cooling fluid from an integrated tank containing the insulating cooling fluid. The insulating cooling fluid may be transformer oil or Ester oil or any type of fluid that is stable at high temperatures and has excellent electrical insulating properties. The fluid inlet 4 is in fluid communication with the stator winding assembly 10 through a tube channel, as shown in FIG. 3.

The insulating cooling fluid is used to cool down the stator winding assembly 10 through heat transfer whilst maintaining the insulation integrity of the stator windings. Thereafter, the insulating cooling fluid is directed out of the electric generator through fluid outlet 5 into the integrated tank,

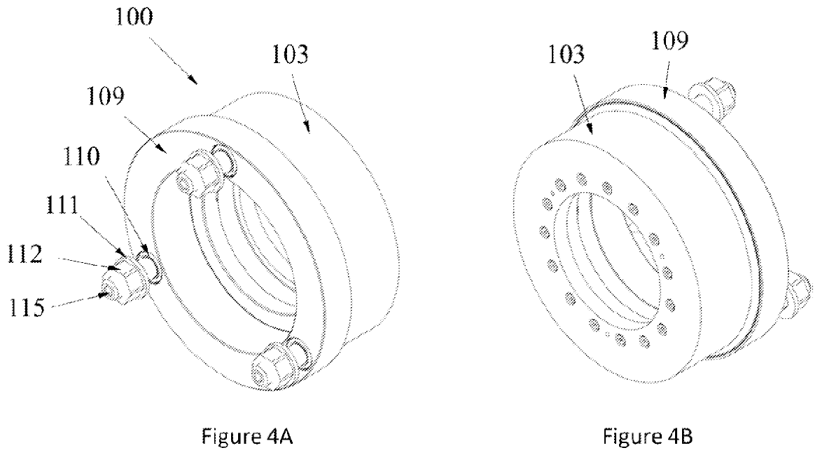

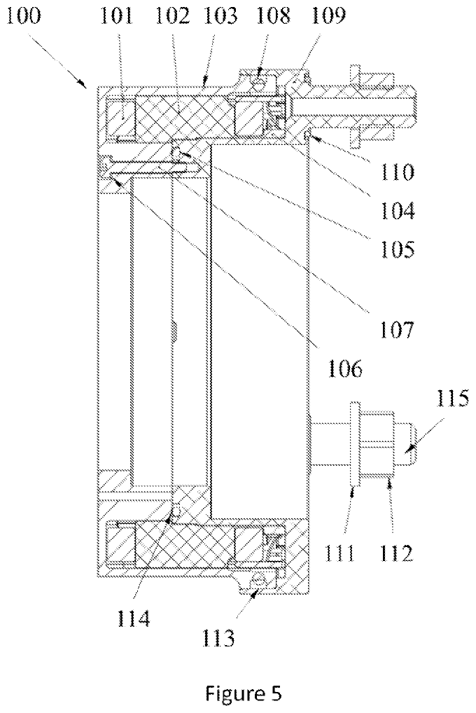

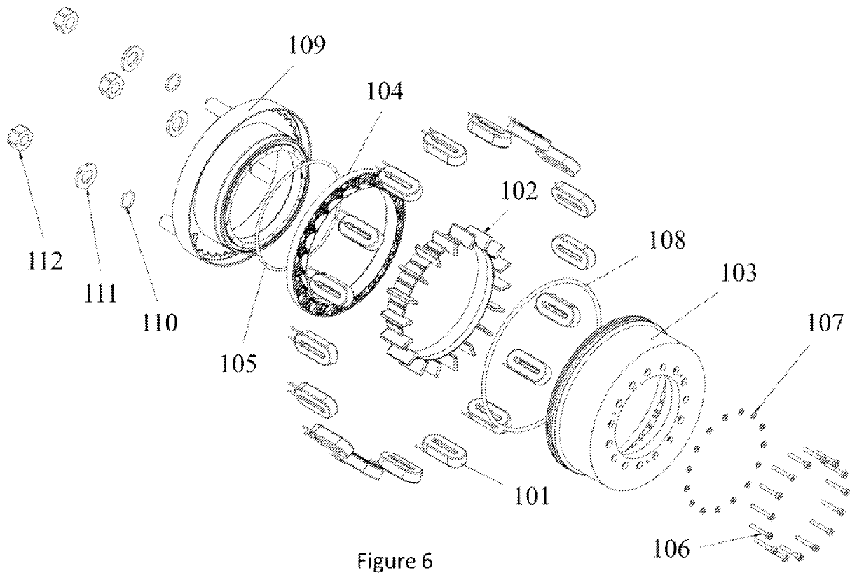

FIGS. 4A, 4B, 5 and 6 show a stator winding assembly 100 according to one embodiment of the invention. The stator winding assembly may be applicable for use with an electric generator, as shown in FIGS. 1A and 1B, or with an electric motor. For the purpose of describing the stator winding, the following provides the non-limiting example for the stator winding used as part of an electric generator, with the skilled person readily appreciating how such a stator assembly may be used with an electric motor.

The stator winding of FIG. 4A includes an outer housing 103 having a coil holder 102 within it. The coil windings 101 are located onto the coil holder 102 at its locating tangs. The type, shape or material of coil windings 101 are flexible. In this embodiment, a typical oval shaped coil with litz wire is used, which is formed by a combination of winding machine and small mould. The coil holder 102 may be made of non-magnetic material and the stator windings will become coreless assembly. Further, thermostatic materials such as Polyetheretherketone (PEEK) or Polytetrafluoroethylene (PTFE) may be used for winding insulation. Compared to conventional epoxy resin used for winding insulation, these materials provide more flexibility in manufacturing and maintenance of the stator winding assembly 100. Also, these materials enable applications in high-pressure and high-temperature conditions with suitable dielectric strength. Their chemical resistance further enables applications in typical oil or gas environment.

The outer housing 103 is designed with necessary slots to assist in the coil orientation alignment. Further, the ribs between the slots in the outer housing 103 act as a reinforcement feature for the stator for under pressure operation, such as in a pressurized compartment. The outer housing 103 may be made of any material suitable for stator windings intended working conditions. It will be appreciated that the outer housing is made of non-magnetic material whereby the interference to the electromagnetic flux interaction between the magnet element and coil is reduced.

A hub 109 may be detachably mounted onto the outer housing 103 using M3 screws 106 to hermetically seal the other components of the stator winding assembly 100 within the casing created by the jointed outer housing 103 and hub 109. The outer housing 103 and hub 109 may be manufactured through machining. Compared to the conventional encapsulation molding used in prior arts, the manufacturing turnaround is faster and cheaper with additional flexibility for revision of the design. Further, unlike the encapsulation molding formed through curing of epoxy resin of the prior art that requires destructive effort for dismantling, the outer housing 103 and hub 109 may be dismantled without damaging any components and allow the coil windings to be taken out of the casing. Thus, it is rather convenient to carry out inspection of the winding conditions and maintenance for the stator winding assembly. Also, it may accelerate troubleshooting activity if required.

There are two bonding surfaces of the outer housing 103 and hub 109 when they are bonded together. The first bonding surface is a cylindrical bonding surface 113 and the second bonding surface is a ring-shape bonding surface 114. The outer housing has seal groove arranged radially at the bonding surface 113 and the steel hub has seal groove arranged axially at the bonding surface 114. O-ring seal 108 is placed radially in the groove at the bonding surface 113 and another O-ring seal 105 is placed axially in the groove at the bonding surface 114 to prevent ingress of unwanted fluid or gas into the stator winding assembly.

The hub 109 serves as the backbone of the assembly and may act as the gateway for electrical leads to be channelled out from the electric generator through its bore holes. As compared to electrical gland connections used for the electrical leads in a prior art device, which offers potential ingress of fluid or gas into the stator winding assembly under pressure operation, hermetic electric connectors are used for these leads to prevent leakage. These bore holes may also serve as the entry and exit points for a cooling medium in situations where cooling of the coil 101 inside the stator is required.

The stator winding assembly 100 may further include a reinforcement ring 104 mounted to the casing to strengthen the stator winding assembly 100 under pressure operation. The reinforcement ring 104 may be made from any material suitable for stator windings intended conditions. Alternatively, the reinforcement ring may be a ridge or raised portion molded into a part of the casing, and so unitarily formed with the casing, or that part of the casing. For those embodiments where the reinforcement ring is a separate element to the casing, it will be appreciated that a non-magnetic material may be used for the reinforcement ring 104 to reduce interference to the electromagnetic flux interaction between the magnet element and coil.

The stator winding assembly 100 may further include three studs 115 located on the hub 109 whereby the stator winding assembly 100 may be installed into the housing of the electric generator. A nut 112 and a washer 111 combination is screwed onto each stud to fasten the installation. Three studs 115 may be a suitable number. In other embodiments, more or less than three studs 115 may also be used for the installation. In this embodiment, the studs 115 are machined with the hub 109. Alternatively, the studs 115 may also be welded or bolted to the hub 109. The hub 109 may further include three seal grooves at the end of each studs, wherein O-ring seals are placed to seal the assembly 100 under pressure operation.

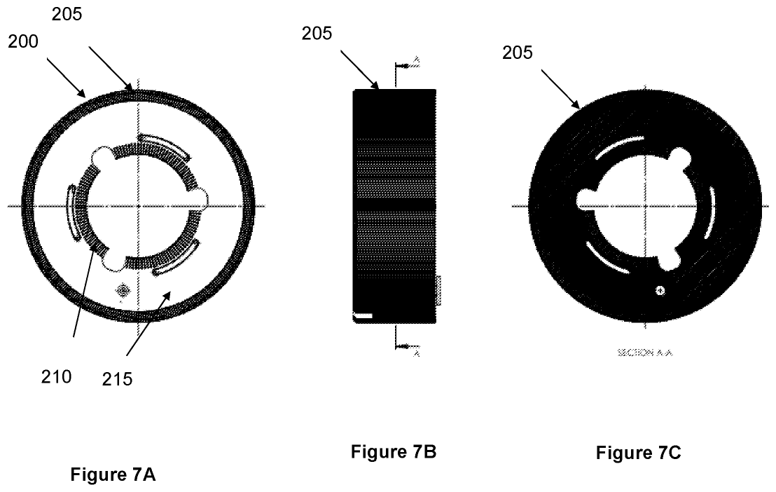

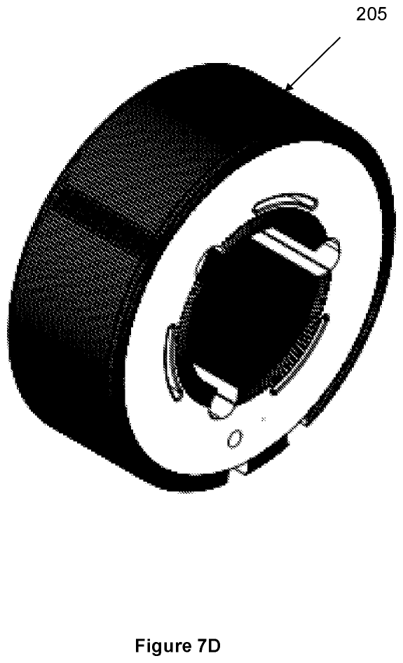

In another embodiment of the invention, FIGS. 7A to 7D show a cooling assembly 200 of the electric machine having a fluid inlet to receive an insulating cooling fluid from an integrated tank containing the insulating cooling fluid. The insulating cooling fluid may be a non-conductive oil, for instance transformer oil. The fluid inlet is in fluid communication with the stator winding assembly through an inner 210 and outer 205 series of tube channels positioned concentrically with the stator assembly, such that the stator winding fits in the interstitial annular space 215 between said tube channels. The transformer oil may be used to cool down the stator winding assembly through heat transfer whilst maintaining the insulation integrity of the stator windings. Thereafter, the transformer oil may be directed out of the electric machine through fluid outlet into the integrated oil tank. Due to turbine gas expansion effect, the low-pressure outflow gas at the outlet of the housing of the electric generator has a very low temperature. A recirculating element may be implemented to recirculate the outflow gas into the oil tank to capitalize the low temperature of the outflow gas and cool down the transformer oil. Further, a pump, for example a submersible pump, may be applied for consistent supply of the transformer oil into the stator winding assembly to increase the cooling efficiency instead of otherwise only relying on natural circulation. This cooling system protects the stator winding assembly from suffering high temperature under long-term continuous operation and ensures a consistent working efficiency of the stator winding assembly. Further, the cooling system improves the stability and durability of the stator winding assembly, as compared to stator winding assemblies without cooling system as shown in the prior art.

1. An electric generator comprising:
a housing;
an inlet for receiving gas into the housing;
a rotor operatively rotatable through contact with the fluid, the rotor having at least one magnetic element attached to its inside;
a stator winding assembly having a coreless stator winding arranged to interact with the magnetic element; and
wherein the stator winding assembly having a dismantlable casing arranged to seal the coreless stator winding from the gas inflow.

2. The electric generator according to claim 1, wherein the dismantlable casing comprises an outer housing and a hub detachably mounted onto the outer housing

3. The electric generator according to claim 2, wherein the coreless stator winding includes a coil holder and coil windings located on the coil holder, the coil windings comprising a thermoplastic material.

4. The electric generator according to claim 3, wherein the thermoplastic material comprises at least one of Polyetheretherketone (PEEK) and Polytetrafluoroethylene (PTFE).

5. The electric generator according to claim 2, wherein the outer housing and hub include grooves at respective bonding surfaces for receiving a sealing member.

6. The electric generator according to claim 2, further including a reinforcement ring mounted to the casing.

7. The electric generator according to claim 2, wherein the casing includes hermetic electric connectors arranged to channel out electrical leads from the electric generator.

8. The electric generator according to claim 2, wherein the coil holder includes a non-magnetic material.

9. An electric generator comprising:
a housing;
an inlet for receiving gas into the housing;
a rotor operatively rotatable through contact with the gas, the rotor having at least one magnetic element attached to its inside;
a stator winding assembly having a coreless stator winding arranged to interact with the magnetic element; and
a cooling system including:
an insulating cooling fluid supplied into the stator winding assembly to cool the coil windings;
a tank containing the insulating cooling fluid, the insulating cooling fluid circulating in between the stator winding assembly and the tank;
a pump arranged to supply the insulating cooling fluid into the stator winding assembly; and
a recirculating element arranged to recirculate the outflow gas into the tank to cool down the insulating cooling fluid through heat transfer.

10. The electric generator according to claim 9, wherein the insulating cooling fluid is a non-conductive oil.

11. The electric generator according to claim 9, wherein the recirculating element is a cooling fin having an inverted finned structure.

12. An electric generator comprising:
a housing;
an inlet for receiving gas into the housing;
a rotor operatively rotatable through contact with the gas, the rotor having at least one magnetic element attached to its inside;
a stator winding assembly having a coreless stator winding arranged to interact with the magnetic element; and
wherein the rotor is arranged to receive the gas inflow to cause the rotation of the rotor.

13. The electric generator according to claim 12, wherein the rotor includes blades uniformly placed about a periphery of the rotor, such that the blades of the rotor are arranged to receive the gas inflow to cause the rotation of the rotor.

14. A stator winding assembly for use with an electric machine, the electric machine comprising:
a housing;
the rotor having at least one magnetic element attached to its inside;
the stator winding assembly having a stator winding arranged to interact with the magnetic element; and
wherein the stator winding assembly having a dismantlable casing arranged to seal the stator winding.

15. The stator winding assembly according to claim 14, wherein the stator winding assembly includes a coreless stator winding.
